(19) United States
(12) Patent Application Publication
(10) Pub. No.: US 2007/0216569 A1
(43) Pub. Date: Sep. 20, 2007

(54) ELEVATION ESTIMATION METHOD AND RADAR APPARATUS USING IT

(75) Inventor: Dedden Gerrit, Ootmarsum (NL)

Correspondence Address: LOWE HAUPTMAN & BERNER, LLP, 1700 DIAGONAL ROAD, SUITE 300, ALEXANDRIA, VA, 22314, US

(73) Assignee: THALES NEDERLAND B.V., HENGELO (NL)

(21) Appl. No.: 11/576,400

(22) PCT Filed: Sep. 28, 2005
(86) PCT No.: PCT/EP05/54870

§ 371 Date: Mar. 30, 2007

(30) Foreign Application Priority Data
Sep. 30, 2004 (NL) 1027151

(51) Int. Cl. G01S 13/02; G01S 13/08

(52) U.S. Cl. 342/123; 342/79

(57) ABSTRACT

The invention relates to an elevation estimation method and a radar apparatus of the stacked beam type using it. For the accurate determination of the elevation of a object, use is made of interpolation on the basis of object strengths, measured in the different beams. Thus, an object of this invention is a method for estimating an object's elevation comprising: receptions and associated receiving processing of signal reflected by the object, a beam transformation of said processed received signals into a number of receiving antenna beams which are at least substantially identical in azimuth direction and distributed in elevation direction, an interpolation of the receiving antenna beams, which are provided with a mutual overlap, such as the object's elevation is deduced by standardization of set of strengths measured along the elevation direction distribution and comparison to pre-defined sets of strengths which have been associated with elevations, the comparison determining a best fitting set. In order to make interpolation also possible for low-flying objects, at least one beam having a negative elevation is provided.

The invention relates to an elevation estimation method and a radar apparatus of the stacked beam type using it. In particular, it relates to radar apparatus comprising a transmitting antenna, transmitting means, and a receiving antennas system, each receiving antenna being fed by associated receiving means, said radar apparatus being suitable for the emission of radar transmit signals and the subsequent reception of reflected radar transmit signals, said reflected radar transmit signals feeding a beam former after reception by the individual receiving antennas and processing by the associated receiving means, in order to obtain a number of receiving antenna beams which are at least substantially identical in azimuth direction and distributed in elevation direction.

A radar apparatus of this type is known from EP-A-0110260. The advantage of a radar apparatus, which forms several beams, at least in elevation direction, is that, from an observed object, the elevation direction is known and also, combined with the usually available range information, the object height. Herewith is the choice of the beam width very important. Firstly, certainty is desired that an object is actually being observed, so that some overlap of the beams is unavoidable. Secondly, an object is minded to be observed in not more than one beam to avoid overloading the video processor connected to the radar apparatus.

This invention solves the above-mentioned drawbacks by interpolating receiving antenna beams, which are provided with a mutual overlap.

An object of this invention is a method for estimating an object's elevation comprising:
Receptions and associated receiving processing of signal reflected by the object,
A beam transformation of said processed received signals into a number of receiving antenna beams which are at least substantially identical in azimuth direction and distributed in elevation direction,
An interpolation of the receiving antenna beams, which are provided with a mutual overlap, such as the object's elevation is deduced by standardisation of set of strengths measured along the elevation direction distribution and comparison to pre-defined sets of strengths which have been associated with elevations, the comparison determining a best fitting set.

Interpolation of the object information originating from the different receiving antenna beams can take place in a variety of ways. An advantageous method is characterised in that the interpolation step comprises the elevation determination on the basis of the strength of the reflected radar transmit signals present at the output of the different receiving antenna beams. By first determining those strengths, interpolation can take place using a number of scalars, for which little hardware is required.

Objects at low elevation, which generally are the most relevant ones, in particular in known radar apparatuses of this type are present in one receiving antenna beam only, which would make interpolation impossible. A further advantageous embodiment of the inventive elevation estimation method is that the beam transformation generates at least one beam having a negative elevation direction. In this way, for a low-elevation object nevertheless two strengths are established, allowing a form of interpolation.

A very advantageous realisation of the elevation estimation method is that the beam transformation generates at least two beams having a negative elevation direction, the transformation preferably generates at least four beams that are equidistant in elevation direction, such that a first beam has a first positive elevation direction, that a second beam has a second, smaller positive elevation direction, that a third beam has a negative elevation direction whose absolute magnitude corresponds to that of the second elevation direction, and that a fourth beam has a negative elevation direction whose absolute magnitude corresponds to that of the first elevation direction. Thus, in the case of a low-elevation object, four strengths are obtained, enabling excellent interpolation.

According to a further very advantageous embodiment, the elevation estimation method according to the invention is characterised in that the interpolation step processes the strengths of reflected radar transmit signals from a object, obtained from the four beams in combination, such as the processing eliminates measuring errors due to lobbing and mirror effect. An advantageous implementation of this embodiment is characterised in that the interpolation determines a quotient of a strength in the fourth beam minus a strength in the first beam to a strength in the third beam minus a strength in the second beam, and reads the elevation of the object within a given table using the quotient.

Another object is a radar apparatus of the stacked beam type being suitable for the emission of radar transmit signals and the subsequent reception of reflected radar transmit signals, using the elevation estimation method according to any of the preceding claims, said radar apparatus comprising:
A transmitting antenna,
Transmitting means,
A receiving antennas system
Receiving means, each receiving means being fed by associated receiving antennas, and
A beam former being fed with said reflected radar transmit signals feeding after reception and processing by the individual receiving antennas and their associated receiving means, said beam former implementing the beam transformation such as to obtain a number of receiving antenna beams which are at least substantially identical in azimuth direction and distributed in elevation direction,
Interpolation means connected to the beam former, said receiving antennas, receiving means and/or said beam former being arranged such as the beam former provides receiving antenna beams with a mutual overlap to the interpolation means, which determines the object's elevation.

An advantageous implementation is characterised in that the interpolation means has been equipped with standardisation means for standardising the object strengths, and with comparison means for comparing the standardised object strengths with a system of previously determined foursomes of standardised object strengths, for determining a best fitting foursome and deriving from it the object elevation.

Further features and advantages of the invention will be apparent from the following description of examples of embodiments of the invention with reference to the drawing, which shows details essential to the invention, and from the claims. The individual details may be realised in an embodiment of the invention either severally or jointly in any combination.

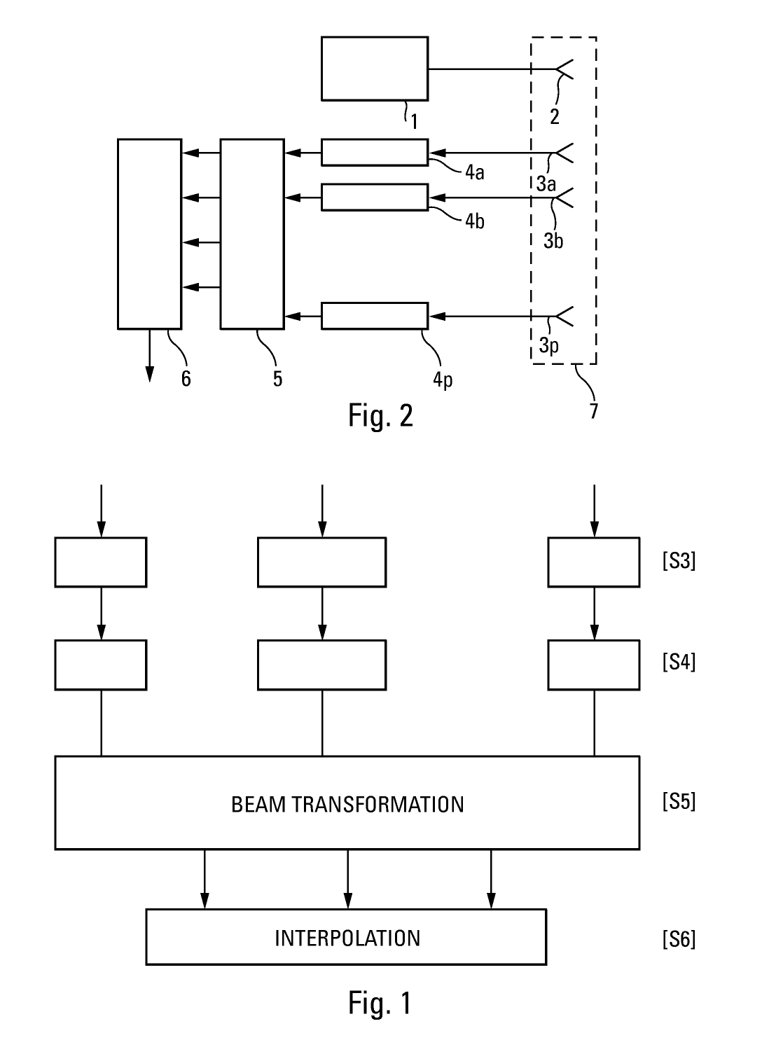

FIG. 1, a block diagram of the elevation estimation method according to the invention,

FIG. 2, a block diagram of the radar apparatus according to the invention,

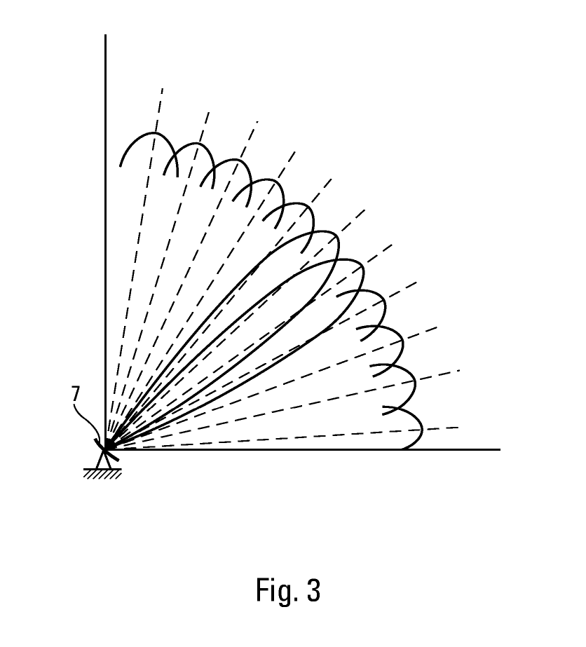

FIG. 3, a radar apparatus comprising eleven receiving antenna beams,

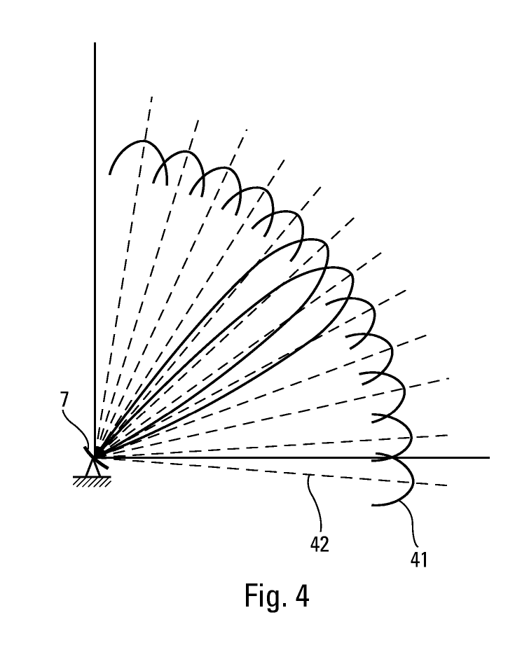

FIG. 4, a radar apparatus comprising twelve receiving antenna beams,

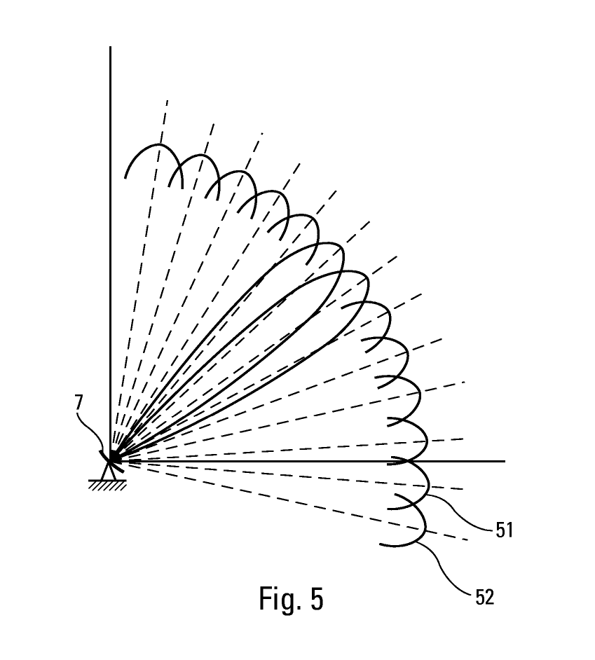

FIG. 5, a radar apparatus comprising thirteen receiving antenna beams.

FIG. 1 shows a block diagram of the elevation estimation method according to the invention comprising a reception step [S3] followed by a receiving processing step [S4] for receiving and further process the signals reflected by the object whose elevation will be estimated. Thus, are obtained several processed received reflected signals. These signals are then transformed during the beam transformation step [S5] in receiving antenna beams with a mutual overlap. The interpolation step [S6] determines from said receiving antenna beams the object's elevation.

FIG. 2 shows a block diagram of a radar apparatus according to the invention, comprising transmitting means 1, a transmitting antenna 2, receiving antennas 3a, . . . , 3p (for example, sixteen receiving antennas), associated receiving means 4a, . . . , 4p, a beam former 5 and interpolation means 6. The transmitting means 1 feed a transmitting antenna 2 with radar transmit signals. The sixteen receiving antennas 3a, . . . , 3p receive the radar transmit signals reflected by a potential object. The reflected radar transmit signals are passed on, via receiving means 4a, . . . , 4p, to a beam former 5. The beam former 5 generates from these reflected signals beams of different elevations, for example, eleven beams as shown in FIG. 3. The output signals of beam former 5 are subsequently applied to interpolation means 6, which accurately determines the elevation of the observed object.

Transmitting antenna 2 and receiving antennas 3a, . . . , 3p are mechanically connected such that their azimuth directions are identical. The individual antennas may comprise a linear array of dipole antennas and a feeder network that is constructed from foam stripline to keep the weight down.

Transmitting antenna 2 and receiving antennas 3a, . . . , 3p may be housed in a common antenna array 7. Antenna array 7 could have been arranged rotatably, such that the radar apparatus is able to provide a 3D representation of the environment, which means that at least the range, the azimuth and the elevation of an object can be determined.

It is possible for transmitting antenna 2 and receiving antennas 3a, . . . , 3p to be combined, with at least one receiving antenna 3i being equipped with Transmit/Receive means, such that also radar transmit signals can make use of the at least one receiving antenna.

Receiving means 4a, . . . , 4p may be of a type that is well known in the radar discipline, preferably of the heterodyne type and provided with a limiter, a low-noise amplifier, and possibly a pulse compression network. Additionally, receiving means may be equipped with clutter suppression means, in particular on the basis of the Doppler effect, for example a canceller or a DFT (Digital Fourier Transform) processor.

The output signals of receiving means 4a, . . . , 4p may be of the analogue quadrature type if beam former 5 is a Butler matrix, and of the digital quadrature type if the beam former comprises a DFT. For each emitted radar signal, the outputs of beam former 5 generate a signal, which can be regarded as split up into range quants. If in a receiving antenna beam a object is observed, the relevant output signal in a range quant corresponding with the distance from the object to the radar apparatus will considerably exceed an always present noise level, which can easily be detected with the aid of a threshold circuit commonly known in the radar discipline. If, in a specific range quant an object is detected in this manner, the receiving antenna beams adjacent to that range quant are also examined if there, too, detection has been made. By ensuring that neighbouring receiving antenna beams overlap, this will always be the case, provided that the object is sufficiently strong, or, in other words, provided that the signal-to-noise ratio is sufficient.

Interpolation means 6 receives the object strengths per range quant for the different receiving antenna beams, and on their basis estimates the current elevation of the object. For this, a linear interpolation on the basis of the object strengths may be used, but better results are attained by standardising the object strengths and subsequently comparing them to a collection of object strengths, calculated for the different elevations.

Interpolation means 6, which preferably operate digitally, may comprise a number of DSPs. If beam generator 5 is arranged as a Butler matrix, the interpolation means will have its inputs provided with A/D converters, which per range quant digitalise the output signals of beam former 5.

If an object is close to the surface of the earth, it may happen that only the lowest beam generates detection, so that an interpolation is not possible. This is especially detrimental because objects of interest preferably are close to the earth's surface. FIG. 4 shows the beams of a first embodiment of the radar apparatus, which avoid this drawback by adding a receiving antenna beam 41 having a negative elevation direction 42. This antenna beam will, as it is well known in the radar discipline, be subject to a mirror reflection from the earth's surface, but will nevertheless generate an additional object strength. This object strength and the object strength generated in the lowest receiving antenna beam of FIG. 3 are dependent on the unknown size and elevation of the object, and on the known frequency of the radar transmit signals, the height of the antennas above the earth's surface and on the known distance from the object to the radar apparatus. It is then possible to calculate, for each frequency, pairs of object strengths, and to compare these with a pair of measured object strengths that were adopted as standards. From this, per emitted radar transmit signal the elevation of the object can be estimated. Through averaging the estimates for a number of successively emitted radar transmit signals, an accurate estimation of the object's elevation is acquired.

A further improvement in determining the elevation of an object can be achieved by adding two negative-elevation beams 51, 52 as shown in FIG. 5. By this means, for a object that is close to the surface of the earth, some four object strengths will be generated, with the strengths again depending on the size and elevation of the object and on the known frequency of the radar transmit signals, the height of the antennas above the surface of the earth, and on the known distance from the object to the radar apparatus. It is then possible to calculate for each frequency a system of foursomes of standardised strengths, and to compare them with a measured object-strength foursome that was adopted as a standard, a best fit, for example on the basis of a least squares method, accurately yielding the elevation of the object. Alternatively, this system of foursomes could be measured in a series of test flights with a object of known radar cross-section, with the test flights needing to be flown at different altitudes, and measurements needing to be made on the operationally significant frequencies.

Comparing foursomes of standardised strengths with a system of foursomes of standardised strengths requires much computing time. It has been found to be possible instead of this to compare a single number with a table, which table, however, may be determined per operationally significant frequency. If the four relevant beams are identified, starting from the topmost one, as beam one, beam two, beam three and beam four, then the number is found by subtracting the object strength in beam four from the object strength in beam one, by subtracting the object strength in beam three from the object strength in beam two, subsequently determining the quotient from the two differences. The table may again be determined per frequency with reference to theoretical considerations, or through executing a number of flights with a object of known radar cross-section, measurements needing to be taken at different frequencies.

In establishing the elevation of a object in this manner, it may happen that the quotient cannot be determined. It is then necessary for the measurement to be executed once more, choosing a different frequency for the radar transmit signals. In more general terms, the determination of a object's elevation will not be based on a single measurement, but on repeatedly measuring at several different frequencies, after which some filtering is still possible.

1. A method for estimating an object's elevation comprising the steps of:
receptions and associated receiving processing of a signal reflected by the object,
a beam transformation of said processed received signals into a number of receiving antenna beams which are at least substantially identical in azimuth direction and distributed in elevation direction,
measuring a set of object strengths by a set of antenna beams substantially identical in azimuth, these beams being provided with a mutual overlap, and comparing with the measured object strengths sets of previously pre-defined standardized strengths, for determining a best fitting set and deriving the elevation of the object from the elevation associated with the best fitting set, and
generating the beam transformation into two beams having a negative elevation direction.

2. The elevation estimation method according to claim 1, wherein said mutual overlap is such as an object is always observed in at least two receiving antenna beams.

3. The elevation estimation method according to claim 1, wherein the interpolation step determines the elevation on the basis of the strength of the reflected radar transmit signals using the different receiving antenna beams.

4. The elevation estimation method according to claim 1, wherein the beam transformation generates at least four beams that are equidistant in elevation direction

5. The elevation estimation method according to claim 1, wherein:
the first beam has a first positive elevation direction,
the second beam has a second, smaller positive elevation direction,
the third beam has a negative elevation direction whose magnitude is equal to that of the second elevation direction, and
the fourth beam has a negative elevation direction whose magnitude is equal to that of the first elevation direction

6. The elevation estimation method according claim 6, wherein the interpolation step processes the strengths of reflected radar transmit signals from a object, obtained from the four beams in combination, such as the strength processing eliminates measuring errors due to lobbing and mirror effect.

7. The elevation estimation method according to claim 1, wherein the interpolation step determines a quotient of a strength in the fourth beam minus a strength in the first beam to a strength in the third beam minus a strength in the second beam, and reads the elevation of the object within a given table using the quotient.

8. A radar apparatus of the stacked beam type being suitable for the emission of radar transmit signals and the subsequent reception of reflected radar transmit signals, using the elevation estimation method according to any of the preceding claims, said radar apparatus comprising:
a transmitting antenna,
transmitting means,
a receiving antennas system (3a, . . . , 3p,
receiving means (4a, . . . , 4p), each receiving means (4a, . . . , 4p) being fed by associated receiving antennas (3a, . . . , 3p), and
a beam former being fed with said reflected radar transmit signals after reception and processing by the individual receiving antennas (3a, . . . , 3p) and their associated receiving means (4a, . . . , 4p), said beam former implementing the beam transformation such as to obtain a number of receiving antenna beams which are at least substantially identical in azimuth direction and distributed in elevation direction,
wherein said radar apparatus further comprises interpolation means connected to the beam former, said receiving antennas (3a, . . . , 3p), receiving means (4a, . . . , 4p) and/or said beam former being arranged such as the beam former provides receiving antenna beams with a mutual overlap to the interpolation means, which determines the object's elevation.

9. The radar apparatus according to claim 8, wherein the interpolation means has been equipped with standardization means for standardizing the strengths, and with comparison means for comparing the standardized strengths with a system of previously determined foursomes of standardized strengths, for determining a best fitting foursome and deriving from it the elevation of the object.

10. The radar apparatus according to claim 9, wherein the interpolation means has been provided with a table enabling, using said quotient, the elevation of the object to be read.

11. The elevation estimation method according to claim 2, wherein the interpolation step determines the elevation on the basis of the strength of the reflected radar transmit signals using the different receiving antenna beams.

12. The elevation estimation method according to claim 2, wherein the beam transformation generates at least four beams that are equidistant in elevation direction

13. The elevation estimation method according to claim 3, wherein the beam transformation generates at least four beams that are equidistant in elevation direction

14. The elevation estimation method according to claim 2, wherein:
the first beam has a first positive elevation direction,
the second beam has a second, smaller positive elevation direction,
the third beam has a negative elevation direction whose magnitude is equal to that of the second elevation direction, and
the fourth beam has a negative elevation direction whose magnitude is equal to that of the first elevation direction.

15. The elevation estimation method according to claim 3, wherein:
the first beam has a first positive elevation direction,
the second beam has a second, smaller positive elevation direction,
the third beam has a negative elevation direction whose magnitude is equal to that of the second elevation direction, and
the fourth beam has a negative elevation direction whose magnitude is equal to that of the first elevation direction.

16. The elevation estimation method according to claim 4, wherein:
the first beam has a first positive elevation direction,
the second beam has a second, smaller positive elevation direction,
the third beam has a negative elevation direction whose magnitude is equal to that of the second elevation direction, and
the fourth beam has a negative elevation direction whose magnitude is equal to that of the first elevation direction.

17. The elevation estimation method according claim 14, wherein the interpolation step processes the strengths of reflected radar transmit signals from a object, obtained from the four beams in combination, such as the strength processing eliminates measuring errors due to lobbing and mirror effect.
